(19) United States
(12) Patent Application Publication
(10) Pub. No.: US 2022/0383667 A1
(43) Pub. Date: Dec. 1, 2022

(54) System and Method for Real-Time Vehicle Data Management

(71) Applicant: Christopher Babcock, Rochester, VT (US)

(72) Inventor: Christopher Babcock, Rochester, VT (US)

(21) Appl. No.: 17/827,673

(22) Filed: May 28, 2022

Related U.S. Application Data
(60) Provisional application No. 63/194,409, filed on May 28, 2021.

(51) Int. Cl. G07C 5/00; B60R 16/033

(52) U.S. Cl. CPC G07C 5/008; B60R 16/033; H02J 7/35

(57) ABSTRACT

Disclosed herein is a system and a method for wirelessly installing one or more data measurement sensors in a vehicle wherein the one or more data measurement sensors operate on unlicensed frequencies. Each of the one or more data measurement sensors are equipped with a sensor module in communication with a main controller through a data communication network. The one or more data measurement sensors are powered independently and not dependent on the aircraft power. The main controller is operable to record, and aggregate the received sensor data from one or more data measurement sensors and transmit to a server arrangement for further processing.

This application claims benefit of provisional application 63/194,409, filed May 28, 2021.

### TECHNICAL FIELD

This disclosure relates generally to the field of electronic data measurement, and more particularly to data management in a movable platform, such as a vehicle.

### BACKGROUND

Access to real time data from a vehicle gives significant insight into the actual running condition of the engine of a vehicle as well as helps in post facto analytics for preventive maintenance. Conventionally, one or more sensors configured for measuring various parameters such as heat, gas, pressure, electric current, or vibration are installed in suitable locations of the vehicles to measure said parameters and relay data to a central electronic controller. Different kinds of sensors can be added to measure one or more different parameters, as desired.

Conventional methods for data measurement can include installation of sensors through electrical wiring around the vehicle. This can require substantive efforts in terms of time and resources. This method of using electrical wiring can not only be cumbersome and costly but may also require interfering with the vehicle's existing electrical systems.

There exists a need for a solution that provides a flexible sensor installation and data management system. In addition, it is desirable to have a system and method that provides for cost effective installation of one or more sensors in a vehicle and allows for efficient data analysis.

### SUMMARY

The present disclosure seeks to provide a system and a method for wireless installation of one or more data measurement sensors in a vehicle wherein the one or more data measurement sensors can operate wireless frequencies and provide performance data. Each of the one or more data measurement sensors are equipped with a sensor module in communication with a main controller through a data communication network. The one or more data measurement sensors are powered independently and not dependent on the vehicle power. The main controller is operable to record and aggregate the received sensor data from one or more data measurement sensors and display selected sensor data for a vehicle operator. Optionally, the main controller may transmit data to a server arrangement for further processing and detailed analysis.

Additional aspects of the present disclosure would be made apparent from the drawings and the detailed description of the illustrative embodiments construed in conjunction with the claims that follow.

It will be appreciated that features of the present disclosure are susceptible to being combined in various combinations without departing from the scope of the present disclosure as defined by the appended claims. It will be appreciated that combined elements of the present disclosure are susceptible to being separated in constituent components without departing from the scope of the present disclosure as defined by the claims.

### BRIEF DESCRIPTION OF THE DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale.

Embodiments of the present disclosure will now be described, by way of example only, with reference to the following diagrams wherein:

FIG. 1 depicts the block diagram of the exemplary system as per the present disclosure.

FIG. 2A shows details of one embodiment of the sensor module.

FIG. 2B shows details of another embodiment of the sensor module.

FIG. 2C shows details of another embodiment of the sensor module.

FIG. 2D shows details of another embodiment of the sensor module.

FIG. 3 shows an embodiment of an exemplary system as implemented in an aircraft.

FIG. 4 shows an embodiment of an exemplary system as implemented in an automobile.

It will be appreciated that the drawings illustrated herein are for representation purposes only and do not intend to limit the scope of the present disclosure. Actual implementations of the present disclosure may be viewed substantially differently yet still practice the presently disclosed systems.

### DETAILED DESCRIPTION

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible. Where specific embodiments are directed towards a specific type of vehicle, that should not be construed as limiting. Other embodiments directed towards other types of vehicles may likewise practice the presently disclosed systems. For example, such types of vehicles may include aircraft (powered or unpowered), automobiles, motorcycles, bicycles, skateboards, rocketships, and trains.

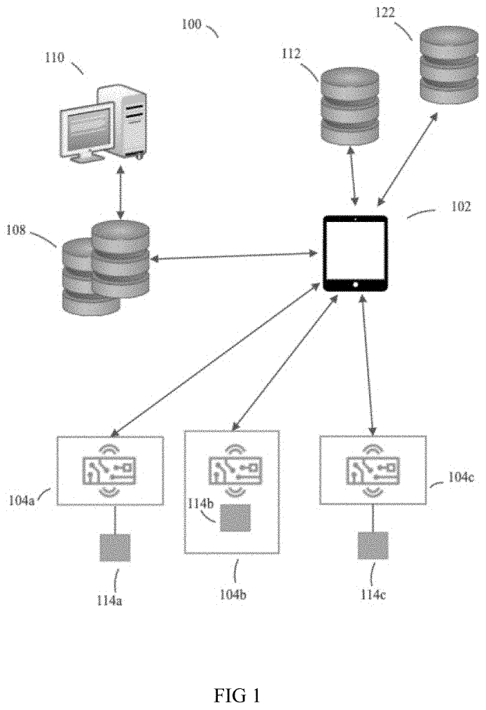

Referring to FIG. 1, the system 100 comprises a main controller 102 and a plurality of sensor modules 104a, 104b, 104c wherein each of the plurality of sensor modules 104a, 104b, 104c may be communicatively coupled to at least one data measurement sensor 114a, 114b, 114c which may be operable to measure one or more parameters of vehicle performance. Individual data measurement sensors may be incorporated as part of the sensor module, as shown for data measurement sensor 114b, which is incorporated as part of sensor module 104b. Alternatively, individual data measurement sensors may be separate from their respective sensor modules, as shown for data measurement sensor 114a, which is separate from sensor module 104a, and as shown for data measurement sensor 114c, which is separate from sensor module 104c. Each of the plurality of the sensor modules 104a, 104b, 104c are communicably coupled to the main controller 102. Main controller 102 may include a processor operative to receive the sensor data and perform calculations on said sensor data. Main controller 102 may include a display device for displaying sensor information for the vehicle operator. Main controller 102 may additionally include an input device for a vehicle operator to select data for display and monitoring. The communication between the sensor modules and the main controller may be via a Bluetooth protocol, an 802.x wireless protocol, or another wireless communication protocol. The main controller 102 may be communicably coupled to a server arrangement 108 external to the vehicle, wherein the server arrangement 108 may be accessible through a client device 110. In one embodiment, the client device 110 may comprise a laptop, desktop or smart phone. In another embodiment, client device 110 may comprise a tablet computer device. Main controller 102 may be operable to transmit data received from the one or more data measurement sensors to the server arrangement 108. Further, the main controller 102 may be connected to a memory storage space 112 for storing sensor data. Memory storage space 112 may be located internal to the vehicle or external to the vehicle. Memory storage space 112 may be a combination of some portions internal to the vehicle, and some portions external to the vehicle. An additional storage space 122 may be located in another location in the vehicle and enclosed in a fire-proof and crash-resistant housing to provide redundant storage of sensor data. Data transmission to additional storage space 122 may be via a wired connection or a wireless connection.

In operation, one or more data measurement sensors 114a, 114b 114c may record readings related to vehicle performance parameters. Performance parameters may include oxygen levels, engine heat, oil temp/pressure, electric consumption.

The sensor readings may be received and interpreted by the associated sensor modules 104a, 104b, 104c. The sensor modules 104a, 104b, 104c then may transmit this data wirelessly using the internal network to the main controller 102. Main controller 102 receives the sensor readings from the plurality of sensor modules and may generate vehicle performance reports and alert an operator to vehicle performance status through a user interface of the main controller 102. Performance reports may include fuel consumption or average air/fuel ratio.

Main controller 102 saves the sensor readings, performance data, and other vehicle data in memory storage space 112 and periodically transmits the sensor readings, performance data, and other vehicle data to server arrangement 108 external to the vehicle. Client device 110 connected to server arrangement 108 may download the sensors readings and performance reports and said information can be further processed for predictive maintenance and performance improvement.

Sensor modules 104a, 104b and 104c may be comprised of an electronic circuit used for interpreting readings from an associated data measurement sensor. While FIG. 1 shows three sensor modules, other embodiments of the present disclosure may include more sensor modules or fewer sensor modules than the number of sensor modules shown in FIG. 1. In embodiments with a single sensor module, the single identifier 104 will be used. Data measurement sensors 114a, 114b and 114c may be operable to measure one or more parameters related to vehicle performance such as gas, heat, pressure, or vibration. While FIG. 1 shows three data measurement sensors, other embodiments of the present disclosure may include more data measurement sensors or fewer data measurement sensors than the number of data measurement sensors shown in FIG. 1. In embodiments with a single sensor module, the single identifier 114 will be used. In an exemplary embodiment, the vehicle is an aircraft. Non-limiting examples of data measurement sensors as per an exemplary embodiment may include Cabin Air Quality, Cabin Oxygen Level, Engine Oil Pressure, Engine Oil Temp, Engine Cylinder Head Temp, Engine RPM, Engine Exhaust Gas Temp, Engine Exhaust O2-Air/Fuel Ratio, Engine Optical Carb Ice Sensor, Engine Air Intake Temp/Humidity (for detecting icing conditions), and Fuel flow. The data measurement sensors may be analog sensor or digital sensors. In an embodiment, the data measurement sensor may be placed in the same housing as the sensor module. Optionally, the sensor module may be placed in a vicinity of the data measurement sensor. Further, each of the data measurement sensors may be associated with a sensor identifier, used herein as an identifier in one exemplary arrangement to allow the microprocessor to identify a sensor in the network.

Sensor modules 104a, 104b, 104c communicate with the main controller 102 wirelessly through the internal network, thereby providing flexibility in terms of positional placement of data measurement sensors in and/or around the vehicle. Previously, data measurement sensors that used wired connections for transmitting readings resulted in limitations on where a data measurement sensor could be placed, often resulting in inaccurate readings due to misplacement of data measurement sensors.

The internal network for data communication between the sensor modules and the main controller may include ZigBee, Z-Wave, BLE or LTE, an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of the foregoing. Sensor modules may use one of said internal networks to transmit sensor readings to the main controller. Optionally, one or more internal networks may be utilized by sensor modules based on specific requirements. As an example, some sensor modules may use Bluetooth while some sensor modules may use Wi-Fi to communicate with the main controller.

A sensor module may be paired with the main controller on an initial setup. The initial setup may comprise the steps of initializing the data communication between the main controller and the sensor module, interacting with test data and calibrating the data measurement sensor. Once in operation, after the initial setup, the sensor module may be operable to communicate, through the internal network, with the main controller to transmit the readings from the data measurement sensor.

Main controller 102 may include a processor configured for wireless communication with the plurality of sensor modules. Main controller 102 is operable to receive sensor readings from each of the plurality of sensor modules through the network. Further, the main controller is configured to store the received sensor readings in memory storage space 112 coupled with the main controller. The memory storage space can be interrogated to retrieve the sensor readings related to individual data measurement sensors based on the sensor identifier. Furthermore, the main controller is equipped with a user interface to configure one or more sensor modules and associated data measurement sensors. The user interface is further used by an operator to analyze the sensor readings and assess a real time vehicle performance and engine health. In an embodiment, the main controller is configured to generate one or more reports depicting real time vehicle performance status. The main controller is operable to raise an alarm in case of sensor readings digressing from optimal values.

Main controller 102 may be equipped with a GPS location unit to track a real time location of the vehicle, and one or more gyroscopic sensors to compute a vehicle path. The computed vehicle path may be stored in the memory storage space 112 and updated in with the movement of the vehicle. The computed vehicle path may be stored in the additional storage space 122 and updated with the movement of the vehicle.

Main controller 102 may be communicably coupled, via a data communication network, with server arrangement 108, such as an external cloud server arrangement. Main controller 102 may be operable to transmit the stored sensor readings, computed vehicle path and reports to server arrangement 108 for further processing and analysis. One or more client devices 110 connected to server arrangement 108 may receive the transmitted information from main controller 102. Client device 110 may comprise any type of computing device, such as a desktop computer system, a laptop, cellular phone, a smart device, a mobile telephone, a tablet style computer, or any other device capable of wireless or wired communication. In some embodiments, client device 110 may be configured to interact with server arrangement 108 via application software installed on the client, such as a web browser or a native application residing on the client device 110. The application software allows for vehicle tracking and engine performance management. One or more software updates to the processor of main controller 102 can be pushed through server arrangement 108 to main controller 102. While FIG. 1 shows a single client device 110, multiple client devices may be operable to access data stored at server arrangement 108.

Optionally, main controller 102 may include one or more navigation functions of the vehicle. In an embodiment, the main controller is provided with a recording device which is used as a vehicle black-box to trace a vehicle path in case of a vehicle crash. The recording device is further provided with an audio recording option to record vehicle audio data.

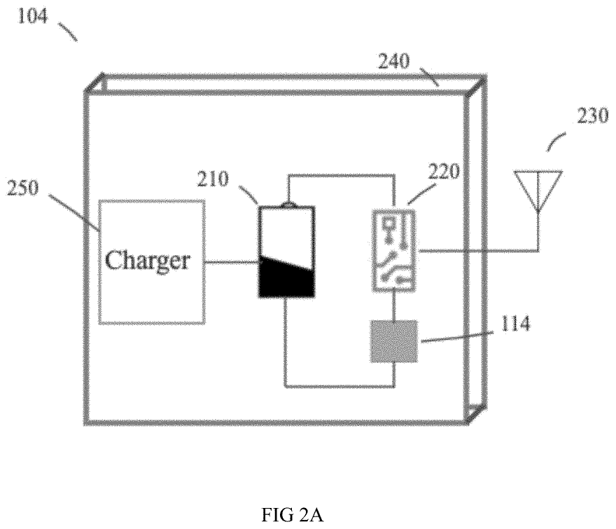

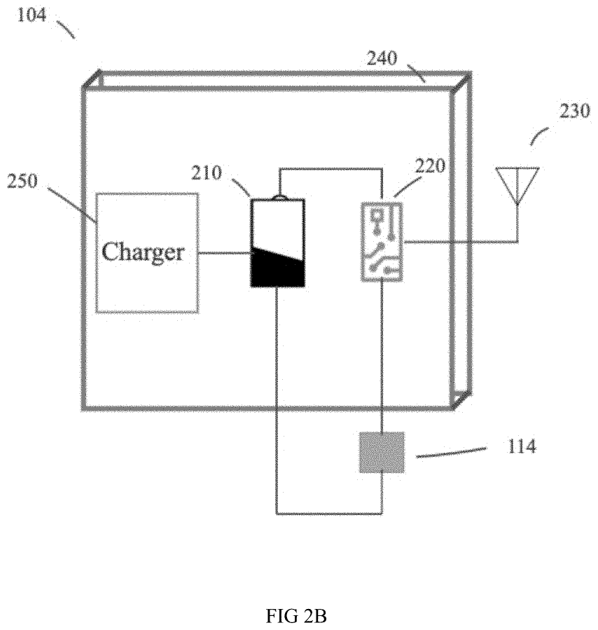

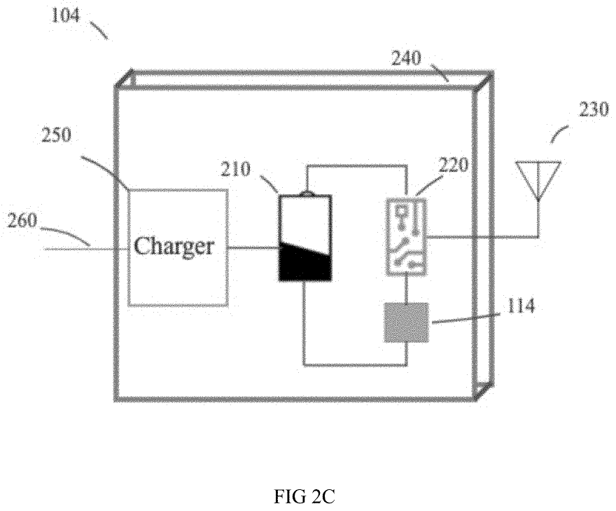

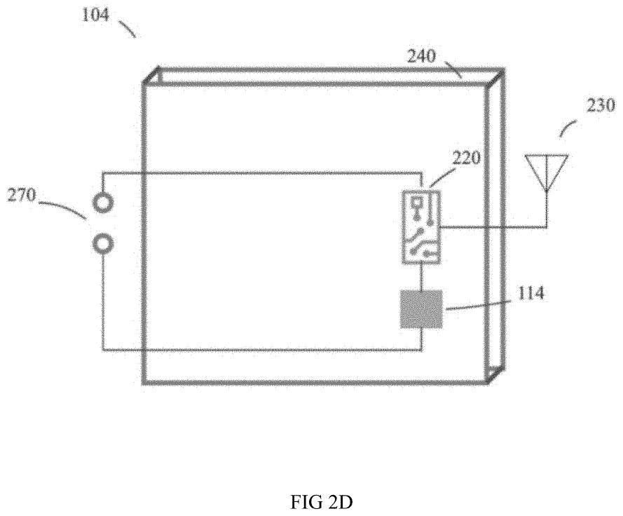

Details of exemplary embodiments of the sensor module are shown in FIGS. 2A, 2B, 2C and 2D. In FIG. 2A, sensor module 104 may include a battery 210, a logic board 220, antenna 230, a data measurement sensor 114 and a charger 250. Sensor module 104 may be enclosed within a housing 240 which protects the electronic circuit from the heat, vibration, water, or other contaminants. Logic board 220 may include circuits, passive and active components for receiving and interpreting data from data measurement sensor 114. Logic board 220 may include a wireless transceiver to provide signals to antenna 230 for wireless transmission to main controller 102. Battery 210 enables the sensor module to be installed at desired remote locations without the limitation of electrical wirings. Without power from the battery, data measurement sensors would need to be installed utilizing vehicle electrical power needed for powering the sensor module, and in turn possibly limiting the positional placement of data measurement sensors, or creating other complexities or costs for installation. Further, the disclosed sensor module does not need to be connected to vehicle power. The sensor module derives the required power for data measurement, processing and transmission from the battery. This further helps in recording data even in case of vehicle power failure since the sensor modules will still be operational and still be able to communicate readings. Sensor module 104 may include a remote charger 250 for the battery. The charger may be configured to charge the battery 210 of sensor module 104 using the heat produced by the vehicle. The charger 250 may utilize a thermo-electric generator connected between the sensor module and a heat source within the vehicle to charge the battery. The battery of the sensor module is configured for charging at voltage levels of at least 3V, which may be generated by a thermo-electric generator using the vehicle heat. In other embodiments, charger 250 may utilize vibrational energy to provide charge for the battery 210. In other embodiments, the charger 250 may utilize solar power to provide charge for the battery 210. Sensor module 104 may include data measurement sensor 114 within the main housing of the sensor module.

FIG. 2B shows another embodiment of sensor module 104. In the embodiment of FIG. 2B, data measurement sensor 114 may be external to the sensor module 104. This embodiment may be utilized in cases where the sensor must be placed in an extreme environment, for example in the engine core to measure oil pressure or temperature. In one embodiment, only the data measurement sensor 114 may be placed in this extreme environment. The remaining components of the sensor module 104 may be placed in a separate location, for example, a location having less extreme environmental conditions.

FIG. 2C is another embodiment of sensor module 104. Charger 250 may be powered from an external power source 260. External power source 260 may be a DC power source or an AC power source. Charger 250 performs required conversions to provide a proper adequate voltage and current to battery 210 for charging.

FIG. 2D is another embodiment of sensor module 104. Logic board 220 and data measurement sensor 114 may be powered directly through power source 270. Power source 270 may provide DC or AC power as required by the logic board 220 and data measurement sensor 114.

The example embodiments of sensor module 104 in FIG. 2A, FIG. 2B, FIG. 2C and FIG. 2D are shown to demonstrate concepts of the sensor management system and are not to be interpreted as limiting. Other implementations may practice the sensor management system or systems disclosed herein using different combinations of external or internal power, external or internal data measurement sensors, or powered or remote battery charging. Implementations of the sensor management system may include sensor modules all of the same design, or may include sensor modules with many different designs within the same sensor management system.

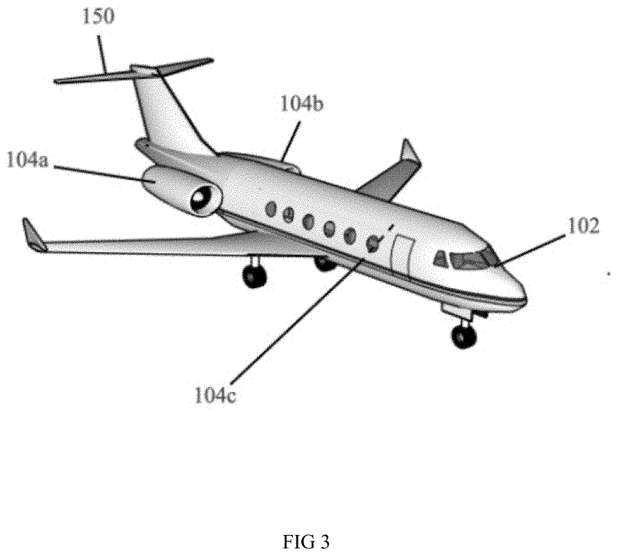

In one embodiment as shown in FIG. 3, the sensor management system is implemented in an aircraft. Main controller 102 may be installed in the cockpit of the aircraft so as to allow access by pilots and navigators. Sensor module 104a may be installed in a first engine side to monitor engine performance metrics. A data measurement sensor communicatively coupled to sensor module 104a measures one or more performance parameters, including but not limited to Engine Oil Pressure, Engine Oil Temp, Engine Cylinder Head Temp, Engine RPM, Engine Exhaust Gas Temp, Engine Exhaust O2-Air/Fuel Ratio, or Engine Optical Carb Ice Sensor. Sensor module 104a communicates wirelessly with main controller 102. Sensor module 104b may be installed in a second engine side to monitor engine performance metrics. A data measurement sensor communicatively coupled to sensor module 104b measures one or more performance parameters, including but not limited to Engine Oil Pressure, Engine Oil Temp, Engine Cylinder Head Temp, Engine RPM, Engine Exhaust Gas Temp, Engine Exhaust O2-Air/Fuel Ratio, Engine Optical Carb Ice Sensor. Sensor module 104b may communicate wirelessly with main controller 102. Sensor module 104c may be installed in the cabin of the aircraft to monitor cabin performance parameters. A data measurement sensor communicatively coupled to sensor module 104c measures performance parameters, including but not limited to Cabin Air Quality and Cabin Oxygen Level. Sensor module 104c may communicate wirelessly with main controller 102. In one embodiment of the sensor management system shown in FIG. 3, main controller 102 may take data inputs from sensor modules 104a, 104b and 104c. In response to information from one or more sensor modules 104a, 104b and 104c, main controller 102 may control one or more modifications to one or more active aircraft systems to compensate for information received from one or more sensor modules 104a, 104b, 104c. In one embodiment, a detection of an undesired change in engine performance by sensor module 104a may result in main controller 102 modifying air/fuel ratio 150 to compensate for a change in engine power.

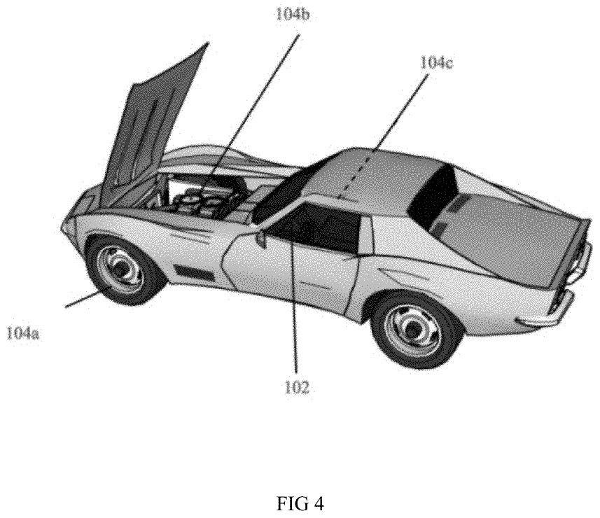

In one embodiment shown in FIG. 4, the sensor management system is implemented in an automobile. Main controller 102 may be installed in the dashboard of the driver's side of the vehicle to allow access by the driver. Sensor module 104a may be installed in the front driver's side tire to monitor tire performance metrics. A data measurement sensor communicatively coupled to sensor module 104a measures one or more performance parameters, including by not limited to tire pressure and speed of rotation. Sensor module 104a communicates wirelessly with main controller 102. Sensor module 104b may be installed in the engine compartment to monitor engine performance metrics. A data measurement sensor communicatively coupled to sensor module 104b measures one or more performance parameters, including but not limited to Engine Oil Pressure, Engine Oil Temp, Engine Cylinder Head Temp, Engine RPM, Engine Exhaust Gas Temp, Engine Exhaust O2-Air/Fuel Ratio. Sensor module 104b may communicate wirelessly with main controller 102. Sensor module 104c may be installed in the cabin of the automobile to monitor cabin performance parameters. A data measurement sensor communicatively coupled to sensor module 104c measures performance parameters, including but not limited to Cabin Air Quality and Cabin Temperature. Sensor module 104c may communicate wirelessly with main controller 102. In one embodiment of the sensor management system shown in FIG. 4, main controller 102 may take data inputs from sensor modules 104a, 104b and 104c. In response to information from one or more sensor modules 104a, 104b and 104c, Main Controller 102 may control one or more modifications to one or more active moving platform systems to compensate for information received from one or more sensor modules 104a, 104b, 104c. In one embodiment, a detection of an increased engine temperature by sensor module 104b may result in main controller 102 modifying engine performance to limit engine RPMs.

The disclosed system may include a plurality of components or subsystems, e.g., connected together by external interface or by an internal interface. In some embodiments, computer systems, subsystems, or apparatuses may communicate over a network. In such instances, one computer may be considered a client and another computer a server, where each may be part of a same computer system. A client and a server may each include multiple systems, subsystems, or components.

It should be understood that any of the embodiments of the present disclosure may be implemented in the form of control logic using hardware (e.g., an application specific integrated circuit or field programmable gate array) and/or using computer software with a generally programmable processor in a modular or integrated manner. As used herein, a processor may include a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Moreover, it will be appreciated that server arrangement 108 can be implemented by way of a single hardware server. Server arrangement 108 can alternatively be implemented by way of a plurality of hardware servers operating in a parallel or distributed architecture. As an example, server arrangement 108 may include components such as a memory unit, a processor, a network adapter, and the like, to store and process information pertaining to the document and to communicate the processed information to other computing components, for example, such as client device 110. Furthermore, server arrangement 108 comprises a database arrangement for storing data therein.

Any of the software components or functions described in this disclosure may be implemented as software code to be executed by a processor using any suitable computer language such as, for example, Java, C, C++, C#, Objective-C, Swift, Perl, or Python. The software code may be stored as a series of instructions or commands on a non-transitory computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The non-transitory computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present disclosure may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can involve computer systems configured to perform the steps of any of the methods described herein, potentially with different components performing a respective step or a respective group of steps. Although presented as numbered steps, steps of methods herein can be performed at the same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the present disclosure. However, other embodiments of the disclosure may involve specific embodiments relating to each individual aspect, or specific combinations of these individual aspects. The description of exemplary embodiments of the disclosure has been presented for the purpose of illustration and description. It is not intended to be exhaustive or to limit the disclosure to the precise form described, and many modifications and variations are possible in light of the teaching above. The embodiments were chosen and described in order to best explain the principles of the disclosure and its practical applications to thereby enable others skilled in the art to best utilize the disclosed various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

We claim:

1. A system for vehicle performance management, comprising:
one or more sensor modules, each of said sensor modules including a wireless communication transceiver and at least one data measurement sensor;
a main controller communicatively coupled to said one or more sensor modules via a network;
a server arrangement communicatively coupled to said main controller;
a client device communicatively coupled to said external server arrangement;
a memory storage space communicatively coupled to said main controller; and
an additional storage space communicatively coupled to said main controller.

2. The system of claim 1, wherein said sensor module further comprises a battery for powering said sensor module.

3. The system of claim 2, wherein said sensor module further comprises a charging unit for charging said battery.

4. The system of claim 3, wherein said charging unit produces charge for said battery from heat produced by said vehicle.

5. The system of claim 3, wherein said charging unit produces a charge for said battery from vibrational energy from said vehicle.

6. The system of claim 3, wherein said charging unit produces a charge for said battery from solar energy.

7. The system of claim 1, wherein said internal network is a wireless communication network.

8. The system of claim 7, wherein said wireless communication network is a Bluetooth network.

9. The system of claim 1, wherein said main controller is operative to transmit data readings and performance reports from said one or more sensor modules to said external server arrangement.

10. The system of claim 1, wherein said main controller further comprises a GPS location unit to track a real time location of the vehicle, and one or more gyroscopic sensors to compute a vehicle path.

11. The system of claim 10, wherein said main controller further comprises a recording device to trace the vehicle path and save said vehicle path to at least one of said external server arrangement, said memory storage space, and said additional storage space.

12. A method of vehicle performance management, comprising:
pairing one or more sensor modules with a main controller;
initiating at least one data measurement operation in at least one of said one or more sensor modules; and
receiving, over a wireless network, data at said main controller from at least one of said one or more sensor modules in response to said data measurement operations.

13. The method of claim 12, wherein said pairing further comprises establishing a unique sensor identifier for each of said one or more sensor modules.

14. The method of claim 12, further comprising initiating a modification of a vehicle system based on said sensor readings.

15. The method of claim 12, further comprising transmitting said sensor readings and said performance reports to at least one of an external server arrangement, a memory storage space and an additional storage space.
